(19) United States
(12) Patent Application Publication
(10) Pub. No.: US 2004/0122734 A1
(43) Pub. Date: Jun. 24, 2004

(54) Points-based rewards automation system and method

(76) Inventors: James R. Schleicher, Londonderry, NH (US); Gustavo D. Silva, Dracut, MA (US); Mohammadi M. Rangwala, Hooksett, NH (US)

Correspondence Address: BUCKLEY, MASCHOFF, TALWALKAR LLC, 5 ELM STREET, NEW CANAAN, CT, 06840, US

(21) Appl. No.: 10/653,683

(22) Filed: Sep. 2, 2003

Related U.S. Application Data
(60) Provisional application No. 60/407,881, filed on Sep. 3, 2002.

(51) Int. Cl. G06F 17/60

(52) U.S. Cl. 705/14

(57) ABSTRACT

A points-based rewards system and method are provided.

### CROSS-REFERENCE

This application is based on, and hereby claims priority to, U.S. Provisional Application Serial No. 60/407,881 filed Sep. 3, 2002, the contents of which are incorporated herein by reference for all purposes.

### FIELD

The present invention relates to rewards systems. In particular, the present invention relates to systems and methods for points-based rewards.

### BACKGROUND

Network marketing techniques are used by a wide variety of companies around the world. Some entities utilize network marketing techniques as their sole means of selling products or services. For example, the Amway Corporation uses a hierarchical network of sales representatives to sell Amway products to consumers. Generally, most of the sales representatives are independent contractors who are paid on a commission basis for their sales. The network involves a hierarchy of representatives who each are encouraged to develop his or her own network of representatives to sell on their behalf.

Network marketing sales using these networks of representatives can be quite successful; however, they present many management problems, including problems of retention, revenue generation, recruiting, and allegiance. In part, these problems arise due to the hierarchical nature of the networks and the fact that each level of the hierarchy is loosely related to the other levels (e.g., unlike a corporation where every sales representative is an employee, the representatives of a network marketing entity are relatively autonomous independent contractors).

It would be desirable to provide systems and methods that allow network marketing entities (or entities which can benefit from network marketing-influenced sales techniques) to exploit rewards programs that may be used to increase revenues and profits, and generally improve key business activity measures and behavior, such as retention, recruiting, best practice compliance, and loyalty.

### SUMMARY

To alleviate problems inherent in the prior art, the present invention introduces a points based rewards automation systems, methods, apparatus, computer program code and means including identifying a rewards sponsor, wherein the rewards sponsor is a member of a network marketing hierarchy, the rewards sponsor associated with a rewards account; identifying terms of a rewards plan, including terms indicating a number of rewards points to be distributed by the rewards sponsor; receiving information from the rewards sponsor indicating a selection of a participant to include in the rewards plan, wherein the participant is a member of the network marketing hierarchy; and establishing the rewards plan.

Pursuant to some embodiments, methods, apparatus, computer program code and means for administering a rewards program in a marketing hierarchy including at least a first and a second participant are provided including receiving a request from a first participant to establish a rewards plan benefiting the second participant; identifying an activity motivated by the rewards plan, the motivated activity including at least one of a performance activity and a vesting activity; identifying a rewards level to be paid to the second participant if the motivated activity is performed; and transferring points equal to the rewards level from an account of the first participant to an account of the second participant if the second participant performs the motivated activity.

Pursuant to some embodiments, methods, apparatus, computer program code and means for receiving rewards include establishing a rewards account with a rewards system; receiving notification of enrollment in a rewards plan, the rewards plan including terms identifying a motivated activity and a rewards amount; performing the motivated activity; and receiving the rewards amount in the form of rewards points deposited in the rewards account, the rewards points including both funded and unfunded points.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a flow chart of a rewards method according to some embodiments.

FIG. 2 is a block diagram illustrating a hierarchy of an organization that may utilize features of some embodiments.

FIG. 3 is a block diagram overview of a system according to some embodiments.

FIG. 4 is a flow chart of a method for establishing a rewards plan according to some embodiments.

FIG. 5 is a flow chart of a method for administering a rewards plan according to some embodiments.

FIG. 6 is a flow chart of a fulfillment and settlement method according to some embodiments.

FIG. 7 is a block diagram of a rewards system server according to some embodiments.

FIG. 8 is a tabular representation of a portion of a plan database according to some embodiments.

FIG. 9 is a tabular representation of a portion of a participant database according to some embodiments.

FIG. 10 is a tabular representation of a portion of a rewards sponsor database according to some embodiments.

FIGS. 11A-B illustrates information displays according to one embodiment of the present invention.

### DETAILED DESCRIPTION

Some embodiments described herein are associated with “network marketing”. As used herein, the term “network marketing” generally refers to different sales models that rely on networks of sales people to sell products or services. For example, three common types of network marketing are multilevel marketing, party plan marketing, and direct sales marketing. Each of these marketing models may utilize embodiments of the present invention to increase revenues, recruiting, loyalty, and retention. As used herein, “network marketing” may also refer to franchise and distributorship models that utilize hierarchical levels of distributors, employees, independent contractors, consultants or sales representatives to sell products or services.

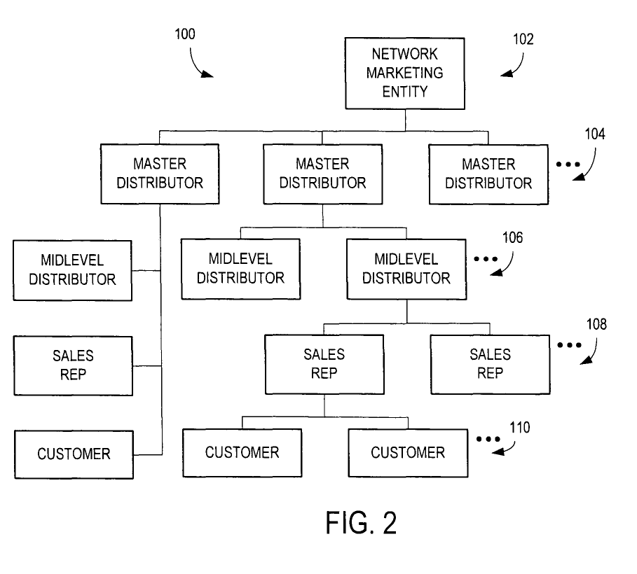

As used herein, the term “network marketing entity” generally refers to an entity (such as a corporation, partnership, franchisor, or other entity) that utilizes network marketing to vend products or services, including entities that sell using a multilevel marketing approach, a direct sales approach, a party plan approach or a franchise approach. In general, features of embodiments may be used to achieve desirable results in a number of different types of sales organizations, particularly where it is desired to influence or reward sales behavior of sales representatives and other participants. An example network marketing entity will be described below in conjunction with FIG. 2.

As used herein, the term “rewards service provider” is generally used to refer to an entity (or group of entities) that operate a network marketing rewards system pursuant to embodiments of the present invention. In some embodiments, the “rewards service provider” is the “network marketing entity”. In some embodiments, the “rewards service provider” is an entity providing rewards services to one or more network marketing entities.

INTRODUCTORY EXAMPLE

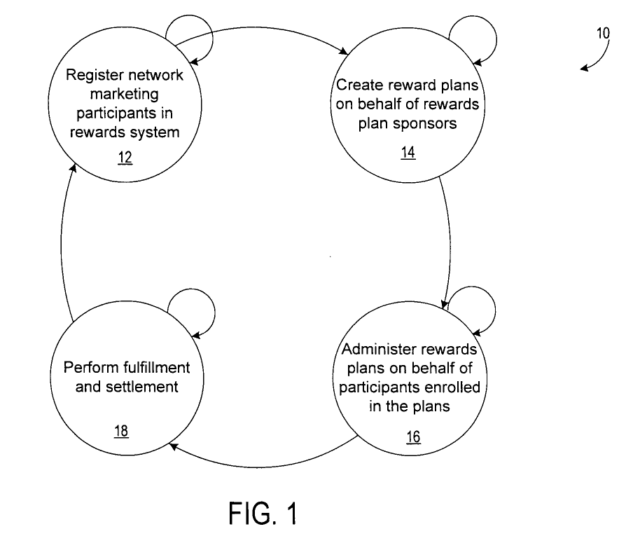

Prior to a more detailed discussion of features of embodiments of the present invention, a brief illustrative example will first be provided by referring to FIG. 1, where a flow diagram 10 depicts a points-based rewards automation method pursuant to some embodiments. In general, and pursuant to some embodiments, rewards processes include the registration of network marketing participants, the establishment of one or more rewards plans, the management or administration of the rewards plans, and the management or administration of fulfillment and settlement activities associated with the rewards plans. Flow diagram 10 is shown as a repetitive process where each step is performed iteratively. In general, each step of the process may be performed a large number of times as participants register, plans are established and administered, and fulfillment and settlement performed. No set sequence is implied, and each of the steps may be performed in any sequence.

As an illustrative example to serve as an introduction to features of embodiments of the present invention, an example network marketing organization will be described which has a network marketing entity as a top level of the hierarchy. The entity sells its products to customers through a hierarchical network of sales representatives. One sales representative (“Joe”) has built a large network of sales representatives who work on his behalf, and enjoys “master distributor” status with the network marketing company. Joe product. Each sales representative also receives a commission. One of the sales representatives in Joe's downline is “Sally”. Sally is starting to recruit sales representatives working on her behalf to build her own downline. Sally is also trying to encourage customers to become repeat customers so that she increases her sales. Embodiments allow each of these types of participants to establish rewards plans to encourage activities of other participants.

In some embodiments, processing starts at 12 where a rewards system is operated by a rewards service provider to register network marketing participants in a rewards system. For example, a rewards service provider may receive instructions from a network marketing entity that every sales representative of the network marketing company be registered as participants in the rewards system (e.g., both Joe and Sally may be registered by the entity as participants). As another example, the network marketing entity may send notices (e.g., via mail or electronic mail) to each of its sales representatives inviting them to register as participants in the rewards system. In some embodiments, current participants may solicit individuals to register as participants (and in some embodiments may receive a commission or fee for successful recruitment of new participants). For example, a current participant may send an email or other notification to an individual inviting them to register to become a participant of the rewards system. The invited individual may initiate the registration process by responding to the email or by following a link or other instructions contained within the email. In some embodiments, the participant who successfully recruits a new participant may receive a commission fee or receive a bonus in the form of rewards points. In some embodiments, both the recruiting participant and the recruited individual may receive rewards points (e.g., the newly recruited participant may receive rewards points to motivate him to become a participant).

Each sales representative or invitee desiring to participate or register in the rewards system may visit a Web site to register as a participant. In some embodiments, different participants may be registered at different program levels. For example, Joe, as a high level sales representative, may register as a “master distributor”, allowing Joe to act as a rewards sponsor and enjoy other program benefits. Sally, as a lower-level representative, may choose to initially register as a basic participant (allowing her to receive rewards points and to participate in rewards plans, but not allowing her to act as a rewards sponsor).

Registration may include establishing rewards accounts for each of the participants. Some participants may also purchase (or be assigned) a point balance in their accounts. For example, Joe, registering as a master distributor, may receive an initial point balance made up of both “funded” and “unfunded” points. The funded points represent points that were paid for by Joe (e.g., Joe may enter into a subscription agreement which provides him with 100,000 funded points in exchange for his payment of a $10,000 membership fee). The unfunded points represent points that Joe did not pay for, but will be required to pay for if (and when) the unfunded points are redeemed by Joe or another participant.

In some embodiments, the number of unfunded points allocated to a participant depends on the price paid for funded points, or the amount of funded points purchased by the participant. In some embodiments, the number of unfunded points depends on the terms of a subscription agreement entered into by the participant (e.g., for Joe's $10,000 membership fee, he may receive 300,000 unfunded points; that is, Joe's subscription agreement may specify that Joe will receive a 3× matching of unfunded to funded points). These funded and unfunded points are associated with the participant's account. Further, the origination or “heritage” of the unfunded points is tracked to allow the rewards system to settle and fund payments owed by each participant when the unfunded points are later redeemed. Some participants may have a rewards account that is set up with an initial balance of zero. For example, since Sally has registered as a basic participant, her account will initially be established with a zero point balance.

Processing may continue at 14 where the rewards system is operated to allow participants to create rewards plans on behalf of rewards plan sponsors and then to administer the rewards plans on behalf of the participants enrolled in the plans. In some embodiments, the rewards system is operated to allow an “authorized sponsor administrator” or other agent to act on behalf of a reward sponsor (for example, a network marketing entity may appoint an administrator to act on its behalf to interact with the rewards system to establish rewards plans pursuant to the present invention.).

As an example, Joe may interact with the rewards system to establish several rewards plans to reward or motivate sales representatives in his downline. As a simple example, Joe may set up one plan (referred to as “plan 1” in this introductory example) which is a “time vesting” plan specifying that each sales representative in his downline will receive 1000 rewards points after six months of sales activity. Joe may further specify that the 1000 rewards points will be paid on a vesting schedule as follows: 25% after two months; 25% after four months; and 50% after six months. Once the plan has been established, processing continues at 16 where the plan is administered to determine if any rewards payouts should occur. For example, the activity of each of the sales representatives participating in Joe's plan may be tracked to identify who is entitled to vested points after two months, four months and six months. Other types of plans may also be established, including, for example, performance vesting plans, instant plans, combination plans, or other plans discussed further below. Joe may also set up a second plan (“plan 2”) which is an “instant” or “ad hoc” plan that provides points to a particular sales representative for the performance of some action. For example, Joe may set up a rewards plan that provides 100 points to Sally to motivate Sally to attend a sales meeting. Again, once the plan has been established, the plan is administered (at 16) to determine if any rewards payout should occur. In this example, “plan 2” is administered by verifying whether Sally attended the sales meeting (e.g., by checking the attendance log of the meeting or by receiving some other confirmation that Sally attended the meeting). If Sally attended the meeting (and upon receipt of confirmation that Sally did attend the meeting), the points are transferred from Joe's account to Sally's account.

Sally may also desire to establish rewards plans. However, as discussed above, Sally initially registered with the system as a basic participant. Pursuant to some embodiments, only certain participants may establish rewards plans. In this example, participants registered as “basic” participants are not authorized to establish rewards plans. In some embodiments, participants can upgrade their subscription terms to become eligible to establish rewards plans. If Sally does so, she may be required to pay an additional subscription fee. In exchange, Sally may receive some amount of funded and unfunded rewards points that she can distribute to other participants through rewards plans. Further, Sally may pass on rewards points that she earns from rewards plans that she is a participant in.

As an example, assume that Sally has upgraded the terms of her subscription agreement so that she is eligible to establish rewards plans. Sally may establish a rewards plan (referred to as “plan 3” in this introduction) that is intended to benefit her customers who purchase certain products from her. Sally may create this plan by specifying the terms of the plan and by designating the participants of the plan. The terms of the plan may then be communicated to the participants so that they know what products to purchase to receive rewards points. For example, Sally's plan may specify that each customer purchasing “product X” before Jan. 1, 2004 will receive 100 rewards points. “Plan 3” is administered (at 16) by identifying Sally's customers who purchase “product X” prior to Jan. 1, 2004 and by transferring 100 rewards points to those customer's accounts from Sally's account.

Processing continues at 18 where fulfillment and settlement activities are performed. In the introductory example, three plans were established and administered. The administration of each of the plans involves monitoring activities of the participants in the plans to determine if rewards points are due under the plan. As discussed above, if rewards points are due, rewards points are transferred from an account associated with the rewards sponsor to an account associated with the participant earning the reward. Participants who have points in their accounts can redeem them for products or services. A catalog of products or services available for redemption may be created by the network marketing entity and made available to all participants in the rewards program. The catalog may specify the number of points needed to purchase an item. In some embodiments, participants other than (or in addition to) the network marketing entity may create or assemble catalogs for use with their rewards plans. For example, a master distributor may select a number of items to be included in a catalog that is used with rewards plans established by the master distributor (e.g., for plans established for his downline). In this manner, rewards sponsors at various levels may select and offer items that are desired or valued by participants in their rewards plans.

In some embodiments, a participant's account may consist of both funded and unfunded points received from one or more rewards sponsors. Further, the participant's account may also include both vested and unvested points. Processing at 18 includes identifying these types of points and performing processing to ensure that only vested points are used to redeem products and to ensure that unfunded points are funded as needed. For example, Sally's account may include 1100 points from Joe, of which 550 of the points are funded points and 550 are unfunded points associated with Joe. Sally may pass some of the points received from Joe to her customers. For example, a customer of Sally's may have a rewards account that has 100 points in it, of which 50 are funded points from Sally and 50 are unfunded points originating from Joe. If the customer wishes to redeem 100 points (e.g., to purchase a 100-point item in a rewards catalog), Joe will be required to fund the unfunded points before the redemption can be completed. Processing at 18 may also allow a participant to “cash up” or purchase an item despite having insufficient vested points in her account to acquire the item. Further features and benefits of embodiments will be described below.

Example Network Marketing Entity

As shown in FIG. 2, a typical network marketing entity has a hierarchical structure 100 including a number of different participants. In the example hierarchy 100 shown in FIG. 2, the hierarchy includes a top level (represented by the entity 102), one or more master distributor levels 104, one or more mid-level distributor levels 106, one or more sales representative levels 108, and customers 110. Different network marketing companies may use different terms for each of these levels, and the terms used herein are intended to be illustrative and used to facilitate description of features of embodiments of the present invention.

As used herein, the term “master distributor” (or “leader”) generally refers to a sales representative or other individual (often having an independent contractor relationship with one or more network marketing companies) who is compensated by one or more network marketing companies based on product sales made on behalf of the network marketing entity(s). As shown in FIG. 2, a master distributor is a sales representative who has attained a high level 102 in the hierarchy 100 of the network marketing entity. As shown in FIG. 2, a sales representative at the master distributor level 104 has a number of individuals at the midlevel distributor level 106 working for him who in turn have a number of individuals at the sales representative level 108 working for them (their “downline”). Each sale benefits both the sales representative making the sale as well as individuals in his or her “upline”. Each of these individuals may, at some point in time, act as a sales representative (e.g., selling products or services of a network marketing entity). As used herein, the term “customers” generally refers to individuals or entities that purchase products from a sales representative of a network marketing entity.

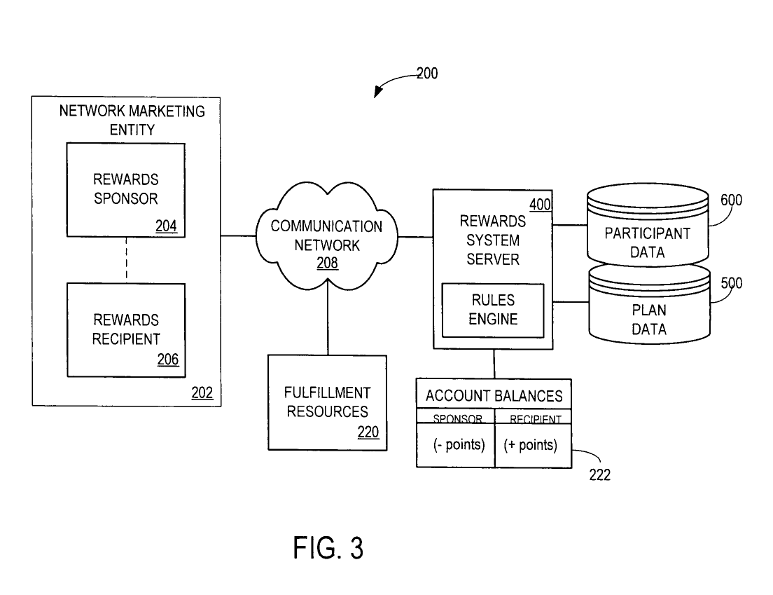

Pursuant to some embodiments, some or all of the participants (other than customer level participants) in the hierarchy of FIG. 2 may act as “rewards sponsors” pursuant to the present invention. For example, a master distributor 104 may act as a rewards sponsor to issue rewards points to participants in his downline (e.g., to motivate particular types of sales activities, to reward retention or loyalty, etc.). Similarly, a lower-level sales representative may act as a rewards sponsor to issue rewards points to customers (e.g., to reward certain types of purchasing activities, etc.). In some embodiments, as will be discussed further below, a participant may act as a rewards sponsor only if the participant has established an appropriate account or entered into a particular type or level of subscription (e.g., with a rewards system operator or other entity operating a rewards system server such as the server 400 of FIG. 3).

As used herein, the term “rewards sponsor” generally refers to a participant (e.g., such as a representative of a network marketing entity) who has elected to issue rewards points to one or more individuals whom the rewards sponsor wishes to incentivize, reward or motivate. For example a midlevel distributor may choose to act as a rewards sponsor so that she may award rewards points to sales representatives working for her (e.g., to motivate certain types of sales behavior or to simply reward loyalty). As shown on the left-hand side of the hierarchy of FIG. 2, a participant at any level (e.g., such as the master distributor) may have a direct association with other participants. For example, a master distributor may continue to have direct customer contact, as well as direct contact with particular sales representatives. Other configurations and hierarchies may also be supported using embodiments of the present invention.

System Overview

FIG. 3 is a block diagram overview of a system 200 according to some embodiments of the present invention. In particular, system 200 is shown having a network marketing entity 202 in communication with a rewards system server 400 via a network 208. Pursuant to some embodiments, rewards system server 400 is operated by a rewards service provider. In some embodiments, the rewards service provider is a separate entity from network marketing entity 202. For example, rewards service provider may be a third party service provider that performs rewards management and administration activities on behalf of one or more network marketing entities. In some embodiments, the rewards service provider is the network marketing entity 202 (e.g., network marketing entity 202 may operate rewards system server 400 to perform rewards management and administration activities on behalf of itself). In either situation, each of the participants (such as rewards sponsor 204 and rewards recipient 206) may enter into a subscription agreement with the rewards service provider defining the terms of their participation in rewards programs operated by the rewards service provider.

Rewards system server 400 stores, or has access to, a number of sets of data and information used to establish and administer rewards plans pursuant to embodiments of the present invention. For example, as shown, rewards system server 400 stores, or has access to, participant data 600, plan data 500 and account data 222. This data (and other data described further below) is used by rewards system server 400 to create, manage, and administer rewards plans pursuant to embodiments of the present invention.

By interacting with rewards system server 400, network marketing entity 202 (and participants associated with entity 202) is able to implement, manage, and encourage the use of rewards and incentive features of the present invention. As shown, network marketing entity 202 has at least a first individual or entity acting as a rewards sponsor 204 and at least a first individual or entity acting as a rewards recipient 206. As discussed above, a typical network marketing entity 202 may have a large number of participants, some or all of which may act as a rewards sponsor and/or a rewards recipient pursuant to embodiments of the present invention (although in some embodiments, participants may need particular subscription terms to act as a rewards sponsor). Each of the participants (such as sponsor 204 and recipient 206) may be associated with a device allowing them to communicate with each other and/or with rewards system server 400. For example, each of the participants may be associated with a computing device such as a personal computer, a wired or wireless telephone, or other devices capable of performing the functions described herein.

Rewards sponsor 204 and rewards recipient 206 may also have a relationship. For example, rewards recipient 206 may be in a sales network associated with rewards sponsor 204 (e.g., recipient 206 may be in a “downline” of sponsor 204). As another example, rewards recipient 206 may be a customer of rewards sponsor 204. Those skilled in the art will appreciate that rewards recipient 206 and rewards sponsor 204 may have any of a number of other relationships in which the sponsor desires to motivate or reward some activity of the recipient utilizing features of embodiments of the present invention.

Pursuant to some embodiments, a network participant acting as rewards sponsor 204 is associated with an account (e.g., such as the sponsor account shown at 222 and stored at, or accessible to, rewards system server 400). The rewards sponsor's account may have a number of funded and unfunded points. Pursuant to embodiments disclosed herein, rewards sponsor 204 may also participate in rewards programs as a rewards recipient. That is, an account balance of rewards sponsor 204 may be increased by deposits received from other network participants.

A network participant acting as a rewards recipient 206 is associated with an account (e.g., such as the recipient account shown at 222 and stored at, or accessible to, rewards system server 400). The rewards recipient's account may have a number of funded and unfunded points. Pursuant to embodiments disclosed herein, rewards recipient 206 may also participate in rewards programs as a rewards sponsor. That is, an account balance of rewards recipient 206 may be reduced by payments made to other network participants based on plans established by rewards recipient 206.

Participants in a rewards system pursuant to embodiments of the present invention (e.g., including network marketing entity 202, rewards sponsor 204 and rewards recipient 206) may interact with each other and with rewards system server 400 over communication network 208. Communication network 208 may be any of a number of different types of networks allowing participants to exchange information and interact with rewards system server 400, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, or an Internet Protocol (IP) network such as the Internet, an intranet or an extranet.

As shown, system 200 also includes fulfillment resources 220 which are accessible to participants of system 200 and to rewards system server 400. For example, fulfillment resources 220 may include a catalog or database of products that may be purchased using rewards points issued to participants. Participants, such as rewards recipient 206, may view products or services contained in a fulfillment catalog and interact with the catalog to redeem points for products or services from the catalog. In some embodiments, fulfillment resources 220 are customized for each network marketing entity 202. For example, a network marketing entity may wish to include it's own products in the catalog in addition to third party products. In this manner, participants can use rewards points to purchase samples or additional products for resale.

Although only a single network is shown, those skilled in the art will appreciate that the network may also consist of a number of networks or communication paths. Moreover, although a single rewards system server 400, a single network marketing entity 202, and individual participants 204, 206 are illustrated in FIG. 3, embodiments may include any number of these devices, participants or organizations. In some embodiments, rewards system server 400 may be operated to provide rewards programs on behalf of a number of different network marketing companies. In some embodiments, rewards system server 400 may be operated by, or on behalf of, a single network marketing entity 202 (e.g., rewards system server 400 may be operated as part of the network marketing entity).

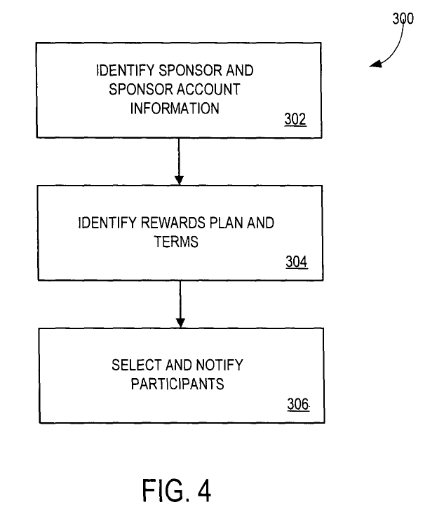

Further features of embodiments will now be described by reference to the flow diagrams of FIGS. 4-6, which depict processes for establishing a rewards plan, administering a rewards plan once it has been established, and managing fulfillment and settlement activities.

Establishing a Rewards Plan

FIG. 4 is a flow chart 300 of a method for establishing a rewards plan according to some embodiments of the present invention. The flow charts described herein do not imply a fixed order to the steps, and embodiments of the present invention may be practiced in any order that is practicable. The process of flow chart 300 may be performed after one or more participants have been registered to participate in a rewards program administered by rewards system server 400.

Process steps of flow chart 300 may be performed by (or under the control or direction of) rewards system server 400. Rewards system server 400 may perform the process in conjunction with information received from one or more participants. Processing begins at 302 where the system is operated to identify a rewards sponsor and rewards sponsor account information. In some embodiments, processing at 302 includes interaction between a participant and rewards system server 400 over the Internet. For example, a participant wishing to create a rewards plan may direct a Web browser on a computer to a URL associated with rewards system server 400 and select an option to log in as a rewards sponsor or to create a new rewards plan.

Rewards system server 400 may then ask the participant to provide identifying information (which may be provided automatically via a cookie or other identifier stored on the participant's computing device). This identifying information is used by rewards system server 400 to retrieve information associated with the participant (e.g., such as information from a participant database 600 and/or information from a rewards sponsor database 700). For example, information may be retrieved which includes information identifying whether the participant is eligible to establish a rewards plan. In some embodiments, participants who have a “basic” or low-level subscription to the service may not establish a rewards plan, while participants who have higher-level subscriptions are entitled to establish a rewards plan. Processing at 302 may include determining whether the participant is eligible to create a plan; if the participant is not eligible, the system may offer the participant an opportunity to upgrade his subscription to a level that does allow the creation of rewards plans. If the participant declines this offer, the process 300 terminates without creating a rewards plan.

If rewards system server 400 determines that the participant is eligible to act as a rewards sponsor and to create a rewards plan processing may continue. In some embodiments, if the participant has never created a rewards plan before, processing at 302 may also include the creation of a new rewards sponsor record in rewards sponsor database 700. In some embodiments, if the participant has previously created a rewards plan, processing at 302 may include the creation of updated information associated with a new plan.

Processing continues at 304 where the system is operated to identify a rewards plan and rewards plan terms. Pursuant to embodiments of the present invention, rewards plans may be identified in a number of ways. For example, processing at 304 may include interaction between the rewards sponsor identified at 302 and rewards system server 400 in which the rewards sponsor custom designs a new rewards plan. Alternatively, the rewards sponsor may interact with rewards system server 400 to select from among a number of pre-existing plans. In either situation (or in a combination of the two where the rewards sponsor modifies portions of a pre-existing plan), the rewards sponsor may specify one or more desired features of the rewards plan. For example, the rewards sponsor may specify any of a number of different terms of the rewards plan, including for example: a rewards amount; a type of plan (e.g., such as a time vesting, performance vesting, instant, combination plan, or a deferred plan including both an instant and a vesting portion); a vesting period (if applicable); performance requirement(s); etc. In some embodiments, the identification of a rewards plan and rewards plan terms may be facilitated through the use of one or more Web pages which include forms, pull-down menus, and/or data entry screens to ease a rewards sponsor's creation of a plan.

Processing continues at 306 where participants are selected and notified of their inclusion in the rewards plan established at 304. For example, in some embodiments, the rewards sponsor may be presented with a list of participants in the sponsor's “downline” who the sponsor may desire to include in their plan. In some embodiments, the sponsor may be allowed to enter new participant information (e.g., such as a participant name, contact information, and an email address). Once the rewards sponsor has selected the sponsor has sufficient rewards points to fund the plan. For example, if a rewards sponsor has an account balance of 500 points, he will not be allowed to create a plan that provides instant rewards of 100 points to each of seven selected participants. However, in some embodiments, a rewards sponsor may establish a vesting plan (either a time vesting, a performance vesting plan or a deferred plan) for which he does not currently have sufficient points to fund the fully vested amount of points. For example, a rewards sponsor having a current account balance of 500 rewards points may set up a time vesting plan in which 7 participants are to receive 100 rewards points each if each participant remains active at the end of a one month period. If, at the end of the vesting period when the points are due to be rewarded, the rewards sponsor does not have sufficient points, the rewards sponsor's account may be charged an amount to fund the deficiency. In some embodiments, the sponsor's account balance must have sufficient rewards points at the time on which the points are vested or paid, otherwise the vested point distribution will be blocked until the deficiency is corrected.

In some embodiments, processing at 306 may include providing the rewards sponsor the option to purchase additional funded rewards points (and/or to acquire additional unfunded rewards points). This may include, for example, consulting the subscription terms of the rewards sponsor to identify the rate or price at which he is eligible to purchase additional funded points. If the rewards sponsor agrees to purchase the additional points, the amount may be charged directly to a financial account (such as a credit or debit card account) provided by the rewards sponsor. If the subscription terms indicate that the rewards sponsor is to receive a matching of unfunded points, these will also be credited to the rewards sponsor's account.

Once the rewards sponsor has selected his desired plan participants (and once sufficient points have been provided to the rewards sponsor to fund the plan with the selected participants), the selected participants are notified of their inclusion in the rewards plan. If the rewards plan is an “instant” or “ad hoc” plan, the notification may also include confirmation that the points have been transferred to the participant's account. For example, if the rewards points were provided for a job well done, an e-mail message or system message may be transmitted to the participant with a thank-you message such as “SALLY—DUE TO YOUR FABULOUS SALES PERFORMANCE IN JULY, I'VE GIVEN YOU A 100 POINT BONUS! THANKS, JOE.”

If the rewards plan requires the performance of some activity, an e-mail message or other message may be transmitted to the participant with information about how to qualify for the rewards points, such as: “SALLY—I'VE SELECTED YOU TO RECEIVE A 1000-POINT RETENTION BONUS! 1000 POINTS HAVE BEEN DEPOSITED IN YOUR ACCOUNT. SELL 4 UNITS IN AUGUST AND YOU WILL BE 50% VESTED. SELL 4 MORE UNITS IN SEPTEMBER, AND YOU WILL BE 100% VESTED! THANKS, JOE”.

In some embodiments, notification of the participants may also include reminders or encouraging messages that remind the participant to continue to (or begin to) perform the incentivized activity to receive rewards points. For example, a reminder message may be transmitted to Sally in conjunction with the above example: “SALLY—YOU HAVE ONE WEEK LEFT IN AUGUST, THERE IS STILL PLENTY OF TIME TO SELL THE 4 UNITS YOU NEED TO VEST IN 500 OF. THE POINTS I DEPOSITED IN YOUR ACCOUNT. YOU CAN DO IT!!” Other reminders and notifications may also be provided to communicate plan terms and plan status to participants. In this manner, rewards sponsors may create rewards plans to motivate and reward specific individuals based on specific activities, thereby increasing revenue, retention, and other desirable actions. Once a rewards plan has been established, rewards system server 400 may operate to administer the rewards plan. While several plans have been discussed, those skilled in the art will appreciate that embodiments allow the creation and administration of a large number of plans at the same time.

In some embodiments, rewards plans may be established that are “co-finded” or where some matching funds are contributed by a participant other than the rewards sponsor. As a particular example, a network marketing entity may determine that sales representative retention is a sufficiently large issue that all sales representatives should be enrolled in time vesting plans designed to reward retention. To encourage adoption of such a time vesting plan by all master distributors in the network marketing hierarchy, the network marketing entity may co-find the plans. As a specific example, the network marketing entity may indicate that it will provide a matching amount of rewards points for each implementation of a particular time vesting plan (“plan 4”). Master distributors may select to adopt “plan 4” and enroll their downline participants in it. For each reward point offered by the master distributor, the network marketing entity may agree to provide a matching number of rewards points. The network marketing entity or other participants may also elect to make an initial subsidy of particular rewards plans (e.g., by agreeing to subsidize some amount of the initial plan cost). In this manner, embodiments allow participants to influence the adoption of particular plans (e.g., to influence critical behaviors or to encourage the adoption of best practices).

Administering a Rewards Plan

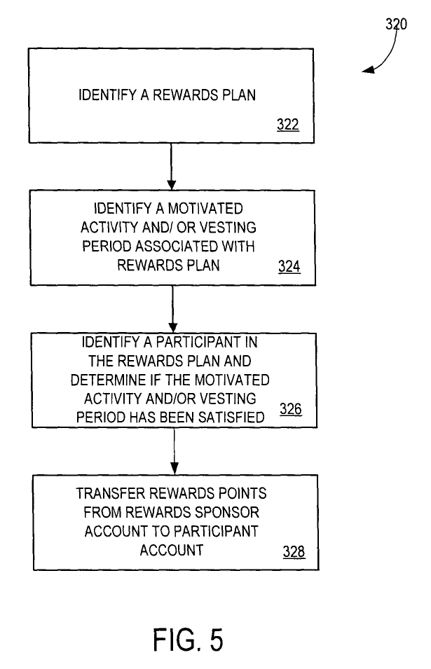

FIG. 5 is a flow chart 320 of a method for administering a rewards plan according to some embodiments. The process of FIG. 5 may be performed once one or more rewards plans have been established (e.g., using the process discussed above in conjunction with FIG. 4). In some embodiments, a rewards system server 400 may administer dozens, thousands, or many more rewards plans. For example, in one embodiment, rewards system server 400 continually monitors rewards plans (e.g., such as the rewards plans stored in a database such as rewards plan database 500) to identify any changes or rewards due under the rewards plans. In some embodiments, the process is performed on a regular or scheduled basis (e.g., the process of FIG. 5 may be performed as a nightly batch process).

The process of FIG. 5 begins at 322 where a rewards plan is identified. For example, processing at 322 may include cycling through each of the active rewards plans managed by rewards system server 400 (e.g., each of the plans included in plan database 500). In some embodiments, processing at 322 may include interaction by an administrator interacting with rewards system server 400 to select one or more plans to administer.

Processing continues at 324 with the identification of a motivated activity and/or vesting period associated with the rewards plan identified at 322. This may include, for example, retrieving plan information associated with the rewards plan from database 500 (and other associated databases as needed). Processing continues at 326 with the identification of a participant in the rewards plan and a determination whether the motivated activity and/or vesting period has been satisfied. In some embodiments, the listing of participants of a particular rewards plan may be stored at plan database 500 and retrieved with other information from the database. Information identifying whether the motivated activity and/or vesting period has been satisfied may be retrieved in a number of different ways. For example, in some embodiments, rewards system server 400 may receive regular data feeds from network marketing entities, including sales information and retention data associated with sales representatives who are participants in rewards plans administered by rewards system server 400. In some embodiments, participants may be required to provide information to rewards system server 400 regarding the completion of certain motivated activities (e.g., as a specific example, a participant who is required to sell 4 products each month may be required to forward the sales confirmation information to rewards system server 400 in order to be eligible to receive rewards under a rewards plan). Other data feeds and sources of information may also be utilized to monitor activities and status of participants.

If processing at 326 indicates that a participant (or participants) have performed the motivated activity (and/or that a vesting period has been satisfied) associated with the rewards plan identified at 322, processing continues at 328 where the system is operated to transfer rewards points from the rewards sponsor account to the participant account. In some embodiments, processing at 328 may include changing the status of points that were previously transferred. For example, a vesting plan may provide that a number of unvested points are transferred to a recipient's account at the start of the plan vesting period. Processing at 328 may include changing the status of the points from “unvested” to “vested” upon the completion of the vesting period defined by the plan. The transfer of points from a rewards sponsor's account to a recipient's account also includes the transfer or recordation of information associated with the “heritage” or origination of any rewards points which are transferred. In some embodiments, for example, this information is tracked to identify which unfunded points have been issued by a reward sponsor and which have been redeemed. For example, if 100 unfunded points originally allocated to “Joe” are transferred to “Sally's” account, information is recorded identifying that the 100 points are associated with an unfunded obligation of Joe. In some embodiments, information associated with the rewards plan is also recorded in the sponsor and recipient accounts (e.g., to provide a detailed accounting record for settlement purposes).

In some embodiments, processing at 328 may also include determining whether any “co-funded” rewards points are to be provided to the rewards recipient. For example, if the rewards plan included some number of points that were matching or “co-funded” points from another rewards sponsor, a determination may be made at 328 and the co-funded rewards points may be transferred from the co-funding rewards sponsor's rewards account to the rewards recipient's account. Rewards from the co-funding rewards sponsor's account may be transferred to the rewards recipient account on the rewards sponsor's behalf.

The process 320 is repeated for each rewards plan that requires administration to ensure that all rewards that have been earned are appropriately credited to the accounts of rewards recipients. In some embodiments, the process 320 may also include processing to generate one or more reminders or encouraging messages to remind rewards participants to take steps to receive their rewards points under any rewards plans they are participants of.

Fulfillment and Settlement

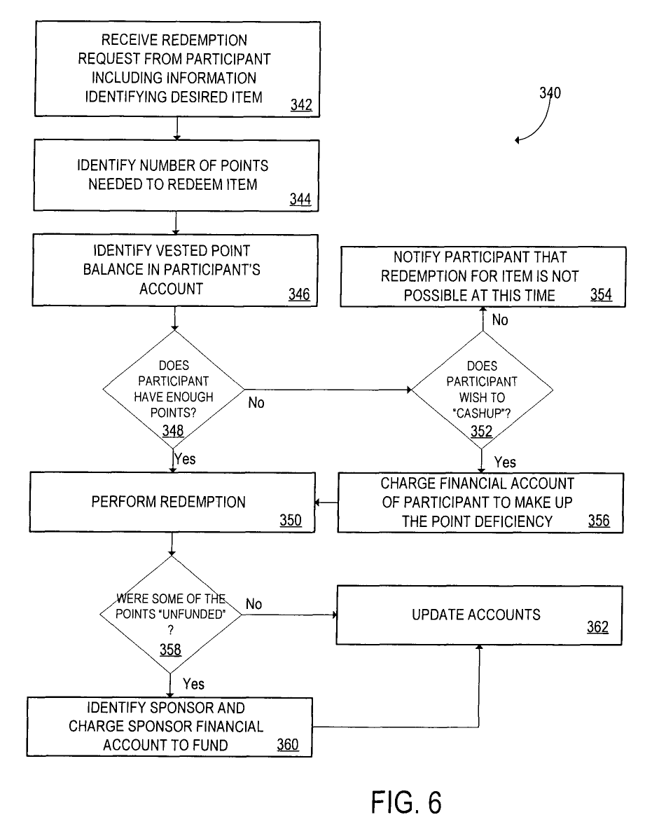

FIG. 6 is a flow chart 340 of a fulfillment and settlement method pursuant to some embodiments. The process of FIG. 6 may be performed under the control of rewards system server 400 on a regular basis (e.g., such as on a nightly or regular batch basis or on a continuous basis as needed). In general, the processing of FIG. 6 is performed after one or more rewards plans have been established (e.g., as discussed in conjunction with FIG. 4, above) and after one or more rewards plans have been administered to transfer points to recipient accounts (e.g., as discussed in conjunction with FIG. 5, above).

Processing begins at 342 where the rewards systems server 400 receives a redemption request from a participant including information identifying a desired item to be redeemed. For example, processing at 342 may occur after a participant who has earned points has selected a desired item from a fulfillment catalog or product listing. In some embodiments, the selection of an item is performed by substantially the same process as the request to redeem. For example, in some embodiments, a fulfillment catalog may be hosted by, or accessible to, rewards system server 400. Participants may view the fulfillment catalog using their Web browser while logged onto the rewards system server 400. A link or button may be provided for each item in the catalog, allowing participants to quickly select to redeem the item (thereby transmitting a redemption request to server 400).

Processing continues at 344 where the rewards systems server identifies the number of points needed to redeem the selected item. In some embodiments, this information may be provided to server 400 as part of the redemption request transmitted at 342. Processing continues at 346 where server 400 identifies the vested point balance in the participant's rewards account (e.g., by referencing participant database 600). Processing continues at 348 where a determination is made whether the participant has sufficient points to acquire the desired item. If the participant has insufficient points, processing continues to 352 where the participant may be given the option to “cash up” or acquire the additional points needed to acquire the desired item. If the participant chooses to use the “cash up” option, the rewards system server 400 calculates the amount of the deficiency and charges the amount to a financial account of the participant (e.g., such as a credit or debit card account) at 356. Processing then returns to 350 to continue redemption. If the participant chooses not to perform the “cash up” option, processing continues at 354 where the participant is notified that redemption for the desired item is not possible at this time.

If processing at 348 indicates that the participant has sufficient points (or if the participant has elected to “cash up” at 356), processing continues at 350 where a redemption is performed. In some embodiments, this includes initiating processing required to order the item from a fulfillment operation and to ship the item to the participant. The points are deducted from the participant's account. In some embodiments, prior to allowing the redemption to be performed at 350, the participant may be required to complete a data survey or response form. For example, a brief data survey form may be presented to the participant prior to completing the redemption process. The survey or data collection may be used to improve best practices, collect sales information or other information to improve operation of the rewards program or the network marketing entity. Once the participant enters the required information, processing at 350 may be completed and redemption may continue.

Processing continues at 358 where a determination is made whether the points deducted from the participant's account to redeem the item include one or more “unfunded” points. If so, the “heritage” of the unfunded points are identified to identify the original issuer of the points at 360. Processing at 360 also includes charging a financial account associated with the original issuer of the points. For example, this may include retrieving information from sponsor database 700 to identify a credit card or other financial account designated by the sponsor and charging an amount to fund the points. In some embodiments, a rewards sponsor is invoiced or otherwise charged the amount. Processing continues at 362 where the accounts of the participant and the sponsor are updated to reflect the redemption. In this manner, recipients may easily and quickly redeem points for items of value.

Rewards System Server

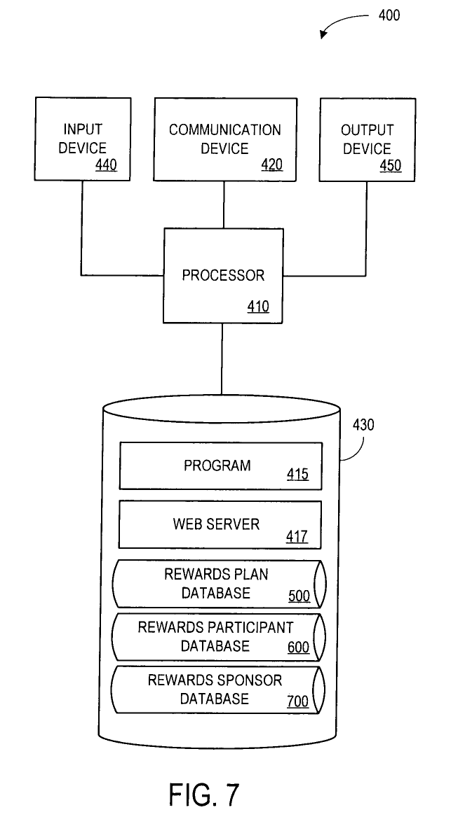

FIG. 7 is a block diagram of a rewards system server 400 according to some embodiments. Rewards system server 400 includes a processor 410, such as one or more INTEL® Pentium® processors, coupled to a communication device 420 configured to communicate via a communication network (not shown in FIG. 7). Communication device 420 may be used to communicate, for example, with one or more devices operated by rewards system participants (e.g., such as personal computers, handheld computing device, wired or wireless telephones, or the like). Note that rewards system server 400 may exchange and/or process information, for example, associated with rewards plans and rewards plan participants.

An input device 440 (e.g., a computer mouse or keyboard) may be used to provide information to rewards system server 400 (e.g., so that an administrator or system operator can interact with the server). An output device 450 (e.g., a display device or printer) may be used to receive information from rewards system server 400.

Processor 410 is also in communication with a storage device 430. Storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Storage device 430 stores a program 415 for controlling the processor 410. Processor 410 performs instructions of the program 415. For example, the processor 410 may be used to control the formation, administration, fulfillment and settlement of rewards programs in accordance with any of the embodiments described herein.

As used herein, information may be “received” by or “transmitted” to, for example: (i) rewards system server 400 from a device operated by another participant of a rewards system; or (ii) a software application or module within rewards system server 400 from another software application, module, or any other source.

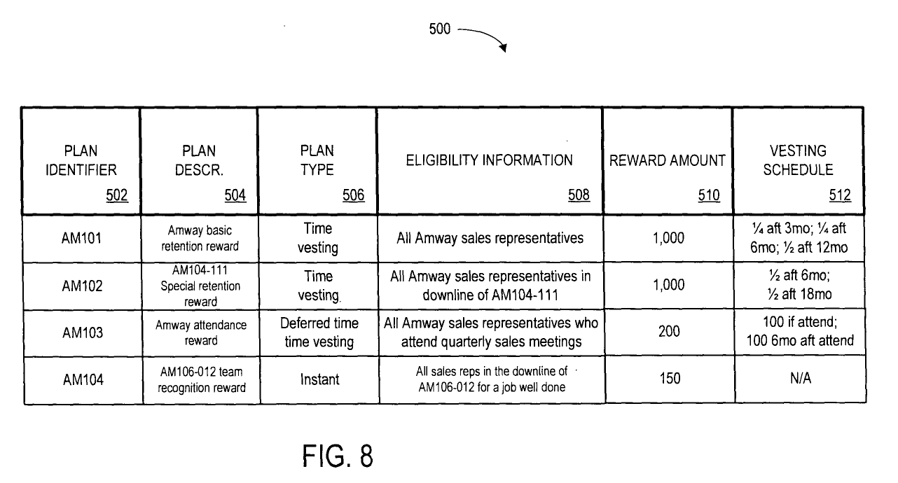

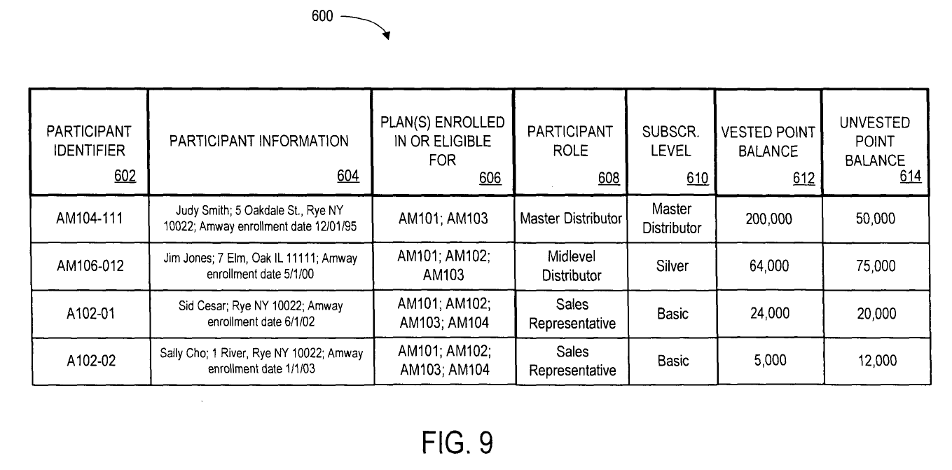

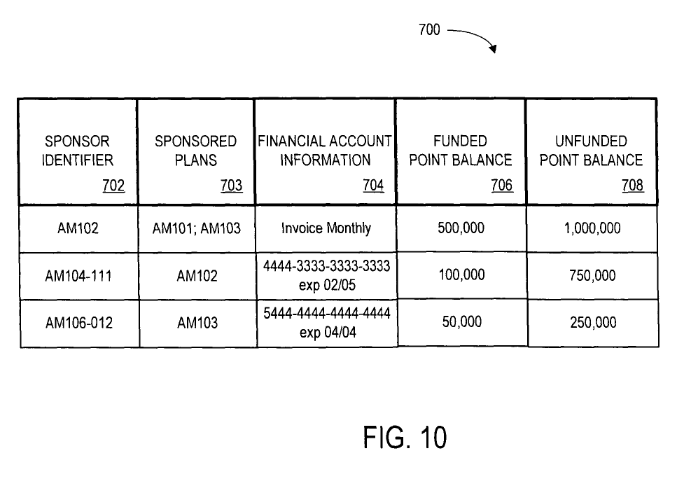

As shown in FIG. 7, storage device 430 also stores a Web server application 417 (e.g., allowing rewards system server 400 to interact with other devices over the Web). Storage device 430 is also shown storing a plan database 500 (described with respect to FIG. 8), a participant database 600 (described with respect to FIG. 9), and a rewards sponsor database 700 (described with respect to FIG. 10).

Rewards Plan Database

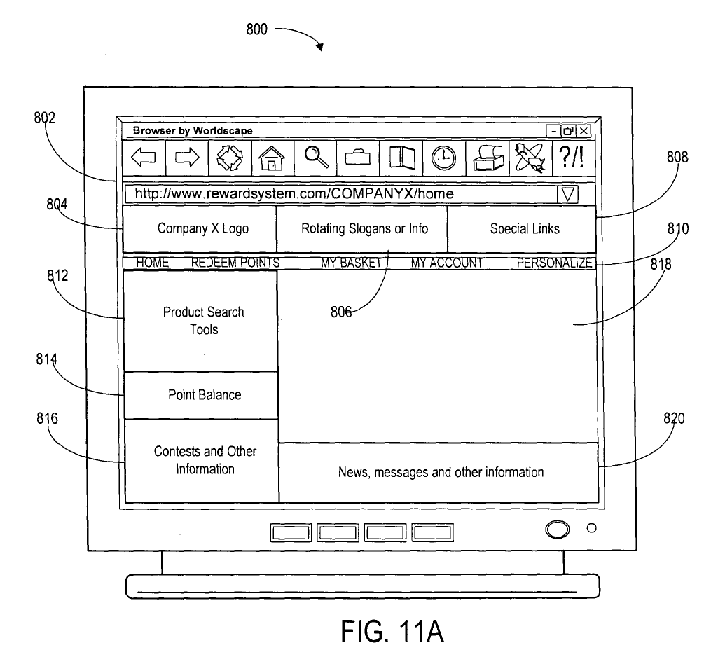

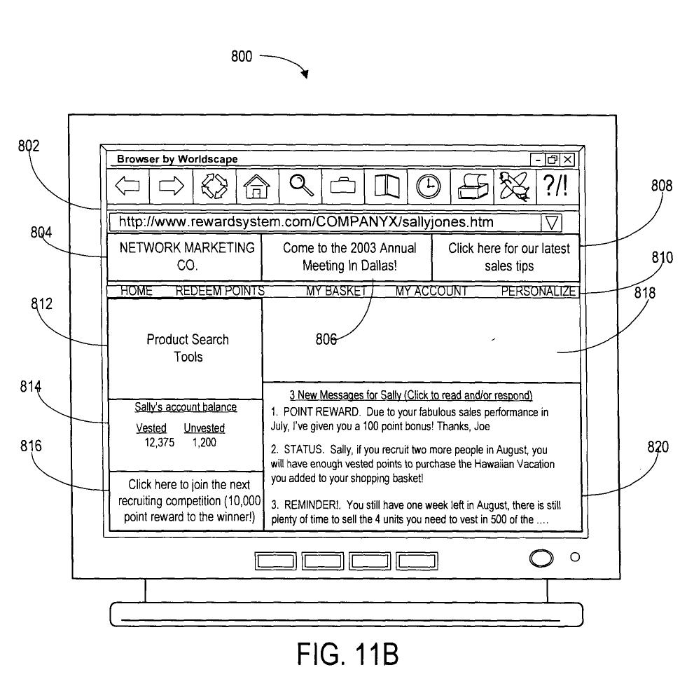

Referring now to FIG. 8, a table represents the plan database 500 that may be accessed by the rewards system server 400 according to an embodiment of the present invention. The table includes entries that define one or more rewards plans established of the entries. The fields specify: a plan identifier 502, a plan description 504, a plan type 506, eligibility information 508, a rewards amount 510 and a vesting schedule 512. The information in plan database 500 may be created and updated based on, for example, information received from a user (e.g., such as from a rewards sponsor who establishes a plan or from an administrator or other operator who enters information on behalf of a plan sponsor or other entity). According to some embodiments, the user may provide the information via a Graphical User Interface (GUI) such as the one described with respect to FIG. 11.

Plan identifier 502 may be, for example, an alphanumeric code or other unique identifier assigned to individual plans to uniquely identify them. Plan description 504 may be, for example, a description of the plan that may be used to reference or otherwise communicate details of the plan to a plan participant. Plan type 506 may be, for example, information identifying a particular type of plan, such as a time vesting plan, a performance vesting plan, a combination plan, an instant plan, or the like. Plan type 506 may be used by rewards system server 400 to select appropriate rules to administer a plan. For example, an “instant” plan will have no vesting schedule associated with it (instead, a rewards amount associated with an “instant” plan will be provided as soon as the plan is established, or as soon as a triggering event is performed by a plan participant and communicated to rewards system server 400). Other types of plans may also be established.

Eligibility information 508 includes, for example, information identifying the participants (or types of participants) that are benefited by the plan. For example, a rewards sponsor may establish a plan that benefits a single participant. This information may be included at 508. As another example, a rewards sponsor may establish a plan that benefits his entire downline (i.e., every participant who shares a commission with the rewards sponsor). Other types of participant identifiers may also be used. In some embodiments, eligibility information 508 may be encoded in a rule format that, when executed, performs conditional logic in order to evaluate eligibility parameters.

Rewards amount 510 includes, for example, information identifying a point amount that will be credited to a participant's account if the participant fully complies with the plan. Vesting schedule 512 includes, for example, information identifying a schedule associated with the plan under which the point amount will be credited. Examples shown in FIG. 8 include plans that have one, two or three vesting periods (e.g., where a participant who is still a member of the network marketing network after a vesting period will receive payments totaling rewards amount 510). Embodiments allow a rewards sponsor to establish a wide variety of different vesting and/or instant rewards to incentivize a wide range of participant behaviors (e.g., including loyalty, performance, retention, recruiting, etc.). Other fields and data structures could also be used; the illustration and accompanying description of database 500 are exemplary, and any number of other database arrangements could be employed besides those suggested by the figure.

Rewards Participant Database

Referring now to FIG. 9, a table represents the participant database 600 that may be accessed by the rewards system server 400 according to an embodiment of the present invention. The table includes entries that identify one or more rewards plan participants who are currently (or may be) enrolled in one or more rewards plans established pursuant to embodiments disclosed herein. The table also defines fields 602-614 for each of the entries. The fields specify: a participant identifier 602, participant information 604, an identification of plan(s) the participant is enrolled in or eligible for 606, a participant role 608, a subscription level 610, a vested point balance 612, and an unvested point balance 614. The information in participant database 600 may be created and updated based on, for example, information received from a user (e.g., such as from a participant who enrolls to participate in the system, from a rewards sponsor who establishes a plan benefiting the participant, or from an administrator or other operator who enters information on behalf of a plan sponsor or other entity). According to some embodiments, the user may provide the information via a Graphical User Interface (GUI) such as the one described with respect to FIG. 11.

Participant identifier 602 may be, for example, an alphanumeric code or other unique identifier assigned to participants to uniquely identify them. Participant information 604 may be, for example, information identifying the participant (such as their name and contact information). The contact information may be used to send reminders and notifications to the participant. Plan information 606 may be, for example, information identifying the specific plans in which the participant identified by the identifier 602 is enrolled or eligible to be enrolled (e.g., this information may refer to plan information in plan database 500 of FIG. 8). Participant role 608 may include information specifying the participant's role in a particular network marketing hierarchy. For example, the information may be used to specify a participant's level (e.g., such as a “master distributor” or a “sales representative”). This information may be used to identify particular groups of participants (e.g., to allow a master distributor to quickly select a group of all midlevel distributors) and to identify whether a participant is eligible for particular subscription terms and privileges (e.g., in some embodiments, only master distributors may be eligible for a “platinum” subscription agreement that provides a high level of benefits).

Subscription level 610 may include information specifying the subscription level that a particular participant has entered into. This may be used, for example, to identify whether a participant is entitled to perform certain actions (e.g., such as to set up a rewards plan and act as a rewards sponsor). This may also be used to calculate the number of unfunded points to provide to a participant. As an example, in some embodiments, several subscription levels may be available to participants having different roles. A “master distributor” may be eligible to purchase a “silver” or “platinum” subscription which provides the master distributor with certain benefits (for example, the master distributor may receive a commission each time a participant in his downline becomes a rewards sponsor subscriber). Each subscription level may have a different subscription fee associated with it (which may be assessed monthly, annually, etc.). In some embodiments, a “master distributor” may also purchase exclusivity rights, allowing the master distributor some exclusivity in operating rewards programs for a particular network marketing entity or within a particular region. A “sales representative” may also have a variety of subscription levels to choose from; however, the subscription terms may not provide the same level of benefits as are provided to a master distributor.

In some embodiments, as discussed above, certain participants may receive rewards points (and/or cash or cash equivalents) based on activities of participants they are associated with in the hierarchy. As an example, the subscription agreement may specify that the master distributor will receive a bonus for each existing participant the master distributor encourages to upgrade their subscription agreement. As a specific example, the master distributor's subscription agreement may specify that the master distributor will receive 10% of the monthly upgrade amount for each upgraded participant in the master distributor's immediate downline. Other commissions and inducements may also be utilized to encourage certain participants to utilize the rewards system.

The vested point balance 612 includes information specifying the point balance that the participant is vested in, while the unvested point balance 614 identifies the unvested balance of the participant. In some embodiments, 612 and 614 may also include information identifying the “heritage” of funded and unfunded points, as well as other accounting information. For example, information identifying the rewards sponsor who issued unfunded points is used to ensure that the rewards sponsor funds the unfunded rewards points when the points are included in a redemption request. Other fields and data structures could also be used; the illustration and accompanying description of database 600 are exemplary, and any number of other database arrangements could be employed besides those suggested by the figure.

Rewards Sponsor Database

Referring now to FIG. 10, a table represents the rewards sponsor database 700 that may be accessed by the rewards system server 400 according to an embodiment of the present invention. The table includes entries that define one or more participants acting as rewards sponsors who have established rewards plans pursuant to embodiments disclosed herein. The table also defines fields 702-708 for each of the entries. The fields specify: a sponsor identifier 702, an identification of sponsored plan(s) 703, financial account information 704, a funded point balance 706 and an unfunded point balance 708. The information in rewards sponsor database 700 may be created and updated based on, for example, information received from a user (e.g., such as from a participant who becomes a rewards sponsor and establishes a plan or from an administrator or other operator who enters information on behalf of a plan sponsor or other entity). According to some embodiments, the user may provide the information via a Graphical User Interface (GUI) such as the one described with respect to FIG. 11.

Sponsor identifier 702 may be, for example, the same as (or based on) participant identifier 602 of participant database 600 and used to identify participants who have become sponsors pursuant to embodiments of the present invention. Sponsored plan(s) 703 may be, for example, an alphanumeric or other identifier assigned to identify each of the sponsored plan(s) established by the sponsor identified by sponsor identifier 702. This information is the same as, or associated with, the plan identifiers 502 of plan database 500. Financial account information 704 may be a credit card account identifier or the like, and related information provided by the sponsor to purchase additional funded rewards points and to fund unfunded points as needed.

Funded point balance 706 and unfunded point balance 708 includes information identifying the account balance of the rewards sponsor which is available to pass on to rewards recipients. Other fields and data structures could also be used; the illustration and accompanying description of database 700 are exemplary, and any number of other database arrangements could be employed besides those suggested by the figure.

Display

FIG. 11A illustrates an information display 800 (e.g., displayed on a computer monitor) according to one embodiment of the present invention. In particular, the display 800 provides a user interface 802 to facilitate interaction between a participant and rewards system server 400. For example, user interface 802 may be used to facilitate interaction for registration, plan setup, redemption, and other processes discussed above. As shown, the user interface 802 is broken into a number of screen areas to facilitate the presentation of information, including an area for a logo 804 (e.g., such as a company logo of a network marketing entity), an area for rotating slogans or information 806 (e.g., such as a slogan associated with the network marketing entity), an area for special links 808 (e.g., such as links to special promotions or information associated with the entity); a tool bar 810 (e.g., providing a participant with quick links to manage his rewards account), an area to perform product searches 812 (e.g., to quickly search for and identify products to redeem), an area displaying a point balance 814 (e.g., showing the participant his current vested and unvested point balance), an area displaying information associated with contests or other information 816 (e.g., displaying special contests or promotions the participant may be entitled to participate in), a primary interface area 818 (e.g., displaying product information, account information or other information selected for view by the participant), and a message area 820 (displaying messages transmitted from other participants, the network marketing entity, or the rewards service provder). This user interface is for illustrative purposes only; those skilled in the art will appreciate that other layouts and formats may also be used to provide desirable results.

An illustrative example of an embodiment of user interface 802 containing example data is shown at FIG. 1B. As shown, user interface 802 is presented to a particular user “Sally Jones”, who is a participant in rewards plans associated with a network marketing entity called “Network Marketing Company”. The network marketing entity uses the interface to display messages to Sally (e.g., such as announcing upcoming meetings, or providing links to sources of sales information and techniques). Further, information specifically targeted to Sally is presented, including her rewards point account balance (showing her vested and unvested balances), an invitation to participate in a competition in which she could earn rewards points, and messages emailed or directed to Sally regarding her participation in rewards plans.

As shown, Sally has received three messages, including a message notifying her of an instant reward that she received, a message reminding Sally that she can acquire sufficient points to purchase an item she previously indicated a desire for if she completes a motivated activity in one of the rewards plans, and a motivational message urging Sally to complete certain sales objectives in order to qualify for a reward. Those skilled in the art will appreciate that other messages, displays, and information may be provided to participants of rewards plans that utilize features of embodiments of the present invention. In this manner, embodiments provide a management and motivational dashboard or interface that allows proactive and reactive participation.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In some embodiments, for example, features of the present invention may be used to implement or introduce network marketing concepts at more traditional companies. For example, a company that does not traditionally employ network marketing concepts (such as AT&T Corp., for example), may utilize features of embodiments to implement and introduce network marketing incentives to it's employees. As a more specific example, AT&T Corp. may adopt or utilize a rewards system of the present invention to motivate or reward employees for performing particular group or group-related activities (such as reducing employee and customer turnover, executing a win-back promotional campaign, meeting sales targets, meeting quality defect objectives, attending industry training, meeting productivity targets, etc.).

Although embodiments have been discussed in which multiple levels of a hierarchy participate in rewards plans, other embodiments may utilize fewer hierarchical levels. For example, embodiments may be implemented in a simple two level hierarchy, where participants in a first level of the hierarchy desire to motivate actions of participants in a second level of the hierarchy. For example, in some embodiments, the first level may establish simple point vesting plans for participants in the second level. In this manner, embodiments allow rewards plans to be established to create incentives to retain employees, other affinity group participants, etc.

Further, although example embodiments have been described herein which relate to establishing and operating rewards plans on behalf of relatively homogeneous networks, embodiments may also be utilized with desirable results in conjunction with heterogeneous hierarchies. For example, an “entity” which influences operations at different associated entities may utilize embodiments to implement rewards plans which desirably influence the activities of participants. As a particular example, assume that an operating company (“Company X”) owns a number of different franchises (“Franchise A” and “Franchise B”) that each respectively have a number of franchises (“Franchise A1”, “Franchisee B1”, etc.), each of which have a number of employees that manage customer relationships. Embodiments of the present invention may be utilized by Company X to establish uniform desired behaviors for each of the levels of this heterogeneous network. For example, if employee turnover and customer retention is an issue for each of the entities, Company X can establish and sponsor rewards plans that are designed to improve employee retention, despite having no direct relationship with individual employees and customer loyalty at the franchisee level. Further, franchisees that develop and implement rewards plans that are particularly successful can share the rewards plans with other franchisees in the organization. Those skilled in the art will recognize that other features and benefits may also be obtained using features of the present invention.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method, comprising:
identifying a rewards sponsor, wherein said rewards sponsor is a member of a network marketing hierarchy, said rewards sponsor associated with a rewards account;
identifying terms of a rewards plan, including terms indicating a number of rewards points to be distributed by said rewards sponsor;
receiving information from said rewards sponsor indicating a selection of a participant to include in said rewards plan, wherein said participant is a member of said network marketing hierarchy; and
establishing said rewards plan.

2. The method of claim 1, wherein said identifying a rewards sponsor further comprises:
identifying subscription terms associated with said rewards sponsor;
determining if said subscription terms authorize said rewards sponsor to establish a rewards plan; and
offering said rewards sponsor revised subscription terms if said rewards sponsor was not previously authorized to establish a rewards plan.

3. The method of claim 1, further comprising:
identifying a number of rewards points in said rewards account of said rewards sponsor, said number of rewards points including a number of funded rewards points and a number of unfunded rewards points.

4. The method of claim 3, wherein said identifying a number of rewards points further comprises:
charging an amount to a financial account of said rewards sponsor to purchase an additional number of funded rewards points.

5. The method of claim 1, further comprising:
identifying subscription terms associated with said rewards sponsor;
charging an amount to a financial account of said rewards sponsor to purchase a number of funded rewards points, said amount determined at least in part on said subscription terms.

6. The method of claim 5, further comprising:
providing said rewards sponsor with a number of unfunded rewards points, said number of unfunded rewards points determined based on said subscription terms.

7. The method of claim 5, further comprising:
providing said rewards sponsor with a number of unfunded rewards points, said number of unfunded rewards points determined based on at least one of: a position of said rewards sponsor in said network marketing hierarchy; said subscription terms; and a credit rating of said rewards sponsor.

8. The method of claim 1, wherein said identifying terms of a rewards plan further comprises determining a type of said rewards plan, said type including at least one of: a time vesting plan; a performance vesting plan; an instant plan; and a deferred plan.

9. The method of claim 1, wherein said establishing said rewards plan further comprises:
determining that said rewards sponsor account balance includes a number of rewards points which are less than a number of points to be paid to said participant under the terms of said rewards plan; and
receiving authorization from said rewards sponsor to increase said number of rewards points by charging an amount to a financial account of said rewards sponsor.

10. The method of claim 1, further comprising:
notifying said participant of said rewards plan and said terms.

11. The method of claim 1, further comprising:
monitoring activity of said participant to determine whether said participant qualifies for a rewards point distribution under said rewards plan.

12. The method of claim 11, further comprising:
reminding said participant of terms of said rewards plan if said monitoring indicates that said participant has not qualified for a rewards point distribution under said rewards plan.

13. The method of claim 11, wherein said monitoring includes receiving data from an entity associated with operations of said network marketing hierarchy.

14. The method of claim 11, further comprising:
transferring a number of rewards points from said rewards sponsor account to a participant account if said participant qualifies for a reward.

15. The method of claim 14, further comprising:
receiving a fulfillment request from said participant, said fulfillment request including information identifying an item and a point value of said item; and
identifying a vested point balance of said participant account.

16. The method of claim 15, further comprising:
determining that said vested point balance is greater than said point value of said item;
deducting a number of vested points equal to said point value from said participant account; and
providing said item to said participant.

17. The method of claim 15, further comprising:
determining that said vested point balance is less than said point value of said item;
receiving authorization from said participant to purchase additional rewards points by charging an amount to a financial account of said participant;
deducting a number of points from said participant account; and
providing said item to said participant.

18. The method of claim 15, wherein said item is at least one of: (a) an item to be resold by said participant; (b) an item to be distributed by said participant as a sample; (c) an item for said participant's personal use; and (d) a gift item.

19. The method of claim 15, wherein said item is an item selected from a rewards catalog, said rewards catalog including items selected by at least one of a network marketing entity and said rewards sponsor.

20. The method of claim 1, wherein said identifying terms of a rewards plan further comprises:
identifying a number of co-funded points to be awarded by a second reward sponsor.

21. A method for administering a rewards program in a marketing hierarchy including at least a first and a second participant, the method comprising:
receiving a request from said first participant to establish a rewards plan benefiting said second participant;
identifying an activity motivated by said rewards plan, said motivated activity including at least one of a performance activity and a vesting activity;
identifying a rewards level to be paid to said second participant if said motivated activity is performed; and
transferring points equal to said rewards level from an account of said first participant to an account of said second participant if said second participant performs said motivated activity.

22. The method of claim 21, wherein said first and second participants are sales representatives of a network marketing entity and wherein said second participant is in a downline of said first participant.

23. The method of claim 21, wherein said receiving a request further comprises:
confirming that said first participant is eligible to establish a rewards plan.

24. The method of claim 21, wherein said receiving a request further comprises:
determining that said first participant is not eligible to establish a rewards plan;
offering said first participant eligibility; and
receiving payment from said first participant in exchange for eligibility to establish said rewards plan.

25. The method of claim 21, wherein said transferring points further comprises:
transferring a number of funded points and a number of unfunded points.

26. The method of claim 25, wherein said unfunded points are associated with said first participant and are caused to be funded when said second participant redeems said unfunded points.

27. The method of claim 21, further comprising:
receiving, from said second participant, a request to redeem points from an account of said second participant to acquire an item; and
determining that a balance of said account of said second participant has sufficient vested points to acquire said item.

28. The method of claim 21, further comprising:
receiving a request to redeem points from an account of said second participant to acquire an item;
determining that a balance of said account of said second participant has insufficient vested points to acquire said item; and
charging an amount to a financial account of said second participant to allow said second participant to acquire said item.

29. The method of claim 21, wherein said network marketing hierarchy further includes a third participant, the method further comprising:
receiving a request from said second participant to establish a second rewards plan benefiting said third participant.

30. The method of claim 29, further comprising:
transferring points from an account of said second participant to an account of said third participant based on said second rewards plan, said points including funded and unfunded points associated with said first and second participants.

31. The method of claim 30, further comprising:
determining that said second participant is no longer a member of said network marketing hierarchy;
charging a financial account of said second participant an amount to fund unfunded points associated with said second participant; and
refunding any remaining points in an account of said second participant to said account of said first participant.

32. The method of claim 30, further comprising:
determining that said second participant is no longer a member of said network marketing hierarchy;
charging a financial account of said second participant an amount to fund unfunded points associated with said second participant; and
canceling any remaining points in an account of said second participant.

33. The method of claim 30, further comprising:
receiving a request to redeem points from an account of said third participant to acquire an item;
determining that a balance of said account of said third participant has sufficient vested points to acquire said item;
determining that said vested points include unfunded points associated with said first participant and unfunded points associated with said second participant; and
causing said first and second participants to fund said unfunded points.

34. A method for receiving a reward, comprising:
establishing a rewards account with a rewards system;
receiving notification of enrollment in a rewards plan, said rewards plan including terms identifying a motivated activity and a rewards amount;
performing said motivated activity; and
receiving said rewards amount in the form of rewards points deposited in said rewards account, said rewards points including both funded and unfunded points.

35. The method of claim 34, wherein said rewards system is operated on behalf of a network marketing entity, said network marketing entity having a network marketing hierarchy, said rewards plan established by a first participant in said network marketing hierarchy to benefit at least a second participant in said network marketing hierarchy.

36. The method of claim 34, wherein said rewards points further include both vested and unvested points.

37. The method of claim 36, further comprising:
receiving confirmation that a portion of said rewards points may be redeemed for an item, said portion equal to a total of said vested points.

38. The method of claim 37, further comprising:
completing a survey prior to redeeming said portion of said rewards points for said item.

39. A rewards device, comprising:
a processor; and
a storage device in communication with said processor and storing instructions adapted to be executed by said processor to:
identify a rewards sponsor, wherein said rewards sponsor is a member of a network marketing hierarchy;
identify a number of rewards points in an account of said rewards sponsor;
identify terms of a rewards plan, including terms indicating a number of rewards points to be distributed by said rewards sponsor;
receive information from said rewards sponsor indicating a selection of a participant to include in said rewards plan, wherein said participant is a member of said network marketing hierarchy; and
establish said rewards plan.

40. A rewards system, comprising:
a first participant device;
a second participant device;
a rewards system server storing a first participant account and a second participant account, said first participant account including funded points and unfunded points;
said first participant device in communication with said rewards system server to establish a rewards plan to benefit a participant associated with said second participant device, said rewards plan identifying a motivated activity and a rewards amount to be paid from said first participant account; and
said second participant device in communication with said rewards system server to receive information regarding said rewards plan.

41. A medium storing instructions adapted to be executed by a processor to perform a method to administer a rewards plan, said method comprising:
identifying a rewards sponsor, wherein said rewards sponsor is a member of a network marketing hierarchy;
identifying a number of rewards points in an account of said rewards sponsor;
identifying terms of a rewards plan, including terms indicating a number of rewards points to be awarded by said rewards sponsor;
receiving information from said rewards sponsor indicating a selection of a participant to include in said rewards plan, wherein said participant is a member of said network marketing hierarchy; and
establishing said rewards plan.

42. A method for participating in a rewards plan as a rewards sponsor, comprising:
identifying that a rewards participant has completed an activity associated with a rewards plan established by said rewards sponsor, said completion of said activity obligating said rewards sponsor to transfer a number of rewards points to an account of said rewards participant;
identifying that said number of rewards points include both funded and unfunded rewards points associated with said rewards sponsor; and
charging an amount to a financial account associated with said rewards sponsor to fund said unfunded rewards points.

43. A method for participating in a rewards plan as a rewards sponsor, comprising:
identifying that a rewards participant has completed an activity associated with a rewards plan established by said rewards sponsor, said completion of said activity obligating said rewards sponsor to transfer a number of rewards points to an account of said rewards participant;
identifying that said number of rewards points include both vested and unvested rewards points associated with said rewards sponsor; and
transferring said number of rewards points to an account of said rewards participant.
